(19) United States
(12) Patent Application Publication
(10) Pub. No.: US 2023/0008691 A1
(43) Pub. Date: Jan. 12, 2023

(54) STATOR INCLUDING ONE-WAY CLUTCH HELD IN A STATOR BODY BY OUTER DIAMETER PORTIONS OF A COVER PLATE

(71) Applicant: Schaeffler Technologies AG & Co. KG, Herzogenaurach (DE)

(72) Inventors: Alfredo Perez Mitre Jimenez, Wooster, OH (US); Juan Bernardo Sosa, Puebla (MX)

(21) Appl. No.: 17/370,433

(22) Filed: Jul. 8, 2021

(51) Int. Cl. F16H 41/26

(52) U.S. Cl. CPC F16H 41/26; F16H 2041/246

(57) ABSTRACT

A stator for a torque converter is provided. The stator includes a plurality of blades; a stator body supporting the blades and defining an annular recess formed therein; a one-way clutch in the annular recess; and a cover plate holding the one-way clutch in the annular recess. An outer diameter portion of the cover plate is received in a circumferentially extending groove of the stator body to axially fix the cover plate to the stator body.

The present disclosure relates generally to stators including one-way clutches and more specifically to torque converter stators.

### BACKGROUND

Torque converter stators include cover plates holding a one-way clutch in a stator body.

### SUMMARY

A stator is provided. The stator includes a plurality of blades; a stator body supporting the blades and defining an annular recess formed therein; a one-way clutch in the annular recess; and a cover plate holding the one-way clutch in the annular recess. An outer diameter portion of the cover plate is received in a circumferentially extending groove of the stator body to axially fix the cover plate to the stator body. The stator as recited in claim 1 wherein the circumferentially extending groove is within the annular recess and the stator body includes a rim portion radially overlapping the outer diameter portion of the cover plate.

In embodiments of the stator, the rim portion may include a radially extending surface defining a wall of the circumferentially extending groove and the radially extending surface of the rim portion may contact a radially extending surface of the outer diameter portion of the cover plate to axially fix the cover plate to the stator body. The rim portion may include a plurality of circumferentially spaced slots and a plurality of circumferentially spaced arc shaped rim segments. The stator body may circumferentially contact the cover plate to circumferentially fix the cover plate to the stator body. The cover plate may include a plurality of radially extending tabs and the stator body may circumferentially contact the radially extending tabs to circumferentially fix the cover plate to the stator body. The stator body may include a plurality of staked sections and each of the staked sections may contact a respective one of the radially extending tabs to circumferentially fix the cover plate to the stator body. The outer diameter portion of the cover plate may be formed by a plurality of radially extending tabs. Each of the radially extending tabs axially may contact a rim portion of the stator body to axially fix the cover plate to the stator body. The outer diameter portion of the cover plate may be formed by a plurality of circumferentially extending prongs. Each of the circumferentially extending prongs may include an outer radial protrusion axially contacting a rim portion of the stator body to axially fix the cover plate to the stator body.

A torque converter is provided including a turbine, an impeller and the stator axially between the turbine and the impeller.

A stator for a torque converter is also provided including a plurality of blades and a stator body supporting the blades. The stator body defines an annular recess formed therein. The stator also includes a one-way clutch within the annular recess, and a cover plate holding the one-way clutch within the annular recess. The cover plate includes radially extending tabs at an outer diameter thereof being received in a circumferentially extending groove of the stator body within the annular recess to axially fix the cover plate to the stator body. The stator body includes staked sections, and each of the radially extending tabs contacts a respective one of the staked sections to circumferentially fix the cover plate to the stator body.

The stator body may include a rim portion radially overlapping the radially extending tabs. The rim portion may include a plurality of circumferentially spaced arc shaped segments, and each of the radially extending tabs axially may contact a radially extending surface of a respective one of the circumferentially spaced arc shaped segments. The stator body may include a plurality of slots extending radially outward from the annular recess, and the slots may divide the rim portions into the plurality of circumferentially spaced arc shaped segments.

A method of forming a torque converter stator is also provided. The method includes providing a cover plate and a stator body including an annular recess; inserting a one-way clutch into the annular recess of the stator body; and axially fixing the cover plate to the stator body so the cover plate holds the one-way clutch in the stator body by inserting an outer diameter portion of the cover plate in a circumferentially extending groove of the stator body.

In some embodiments of the method, the outer diameter portion of the cover plate may be formed by a plurality of radially extending tabs. The circumferentially extending groove may formed by a plurality of circumferentially extending grooves and the stator body may include a plurality of slots extending radially outward from the annular recess. The inserting of the outer diameter portion of the cover plate in the circumferentially extending groove of the stator body may include pressing each of the tabs into a respective one of the slots, and rotating the cover plate to force each of the radially extending tabs into a respective one of the circumferentially extending grooves. The method may further include axially staking the stator body to circumferentially fix the cover plate to the stator body. The outer diameter portion of the cover plate may be formed by a plurality of circumferentially extending prongs and the circumferentially extending groove may be formed by a plurality of circumferentially extending grooves. The inserting of the outer diameter portion of the cover plate in the circumferentially extending groove of the stator body may include forcing the circumferentially extending prongs radially inward while pressing the cover plate into the annular recess.

### BRIEF DESCRIPTION OF THE DRAWINGS

The present disclosure is described below by reference to the following drawings, in which:

FIG. 1 schematically shows a cross-sectional side view of a torque converter in accordance with an embodiment of the present disclosure;

FIG. 2 shows an enlarged cross-sectional side view of the stator that is circumferentially offset from the view of the stator shown in the torque converter in FIG. 1;

FIG. 3 illustrates an exploded view of the stator;

FIG. 4a shows a standalone perspective view of the stator casting;

FIG. 4b shows a perspective view of the casting with the cover plate omitted;

FIG. 5 shows an enlarged view of a portion of the stator body shown in FIG. 4;

FIG. 6 shows a cross-sectional view of a portion of the stator;

FIGS. 7 to 11 illustrates a method of constructing stator by installing a cover plate into an annular recess and fixing tabs of the cover plate in circumferentially extending grooves; and

FIGS. 12 to 15 illustrate a further example of a cover plate for fixing in an annular recess of a stator body.

### DETAILED DESCRIPTION

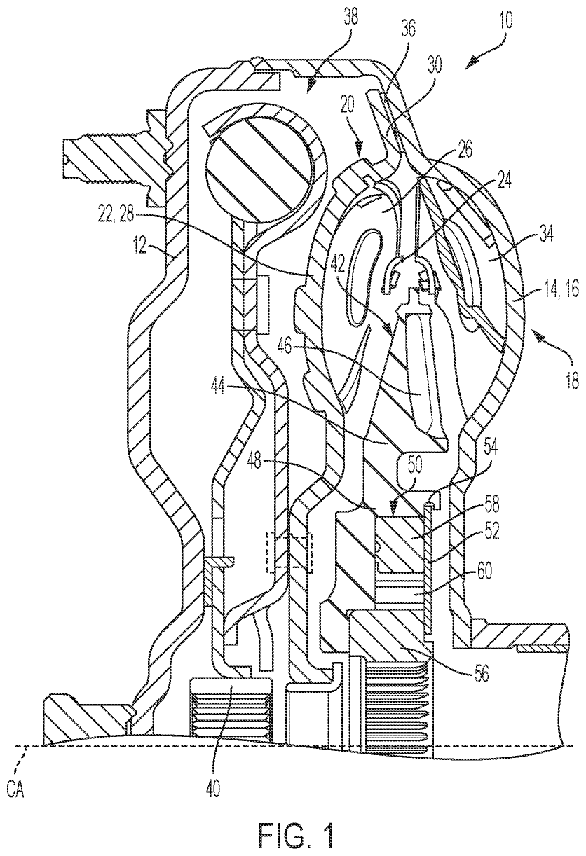

FIG. 1 shows a cross-sectional side view of a torque converter 10 in accordance with an embodiment of the present disclosure. Torque converter 10 includes a front cover 12 for connecting to a crankshaft of an internal combustion engine and/or an output of an electric motor, and a rear cover 14 forming a shell 16 of an impeller or pump 18. Torque converter 10 also includes a turbine 20 that is configured as a piston such that turbine 20 is axially moveable toward and away from impeller 18 to engage and disengage impeller 18 so as to form a lockup clutch. Turbine 20 includes a turbine shell 22 and an inner ring 24 supporting a plurality of turbine blades 26 therebetween. Turbine shell 22 includes a rounded blade supporting portion 28 for supporting of turbine blades 26 at a front cover side of the blades 26. Radially outside of blade supporting portion 28, turbine shell 22 includes an outer radial extension 30 radially protruding outwardly from an outer circumference of blade supporting portion 28. Impeller shell 16 along with a core ring 32, supports a plurality of impeller blades 34.

A friction material 36 is bonded onto a surface of outer radial extension 30 for engaging impeller shell 16. A damper assembly 38 is positioned between front cover 12 and turbine 20 and is configured for transferring torque from turbine 20 to a transmission input shaft via a hub 40.

Outer radial extension 30 of turbine 20 engages impeller 18 via friction material 36 to transfer torque input into front cover 20 by the internal combustion engine crankshaft and/or the electric motor to the transmission input shaft. As turbine 20 is driven by impeller 18, either through contact via friction material 36 and impeller shell 16 when the lockup clutch is locked or through fluid flow between blades 26, 34, turbine 20 transfers torque to damper assembly 38, which in turn drives the transmission input shaft.

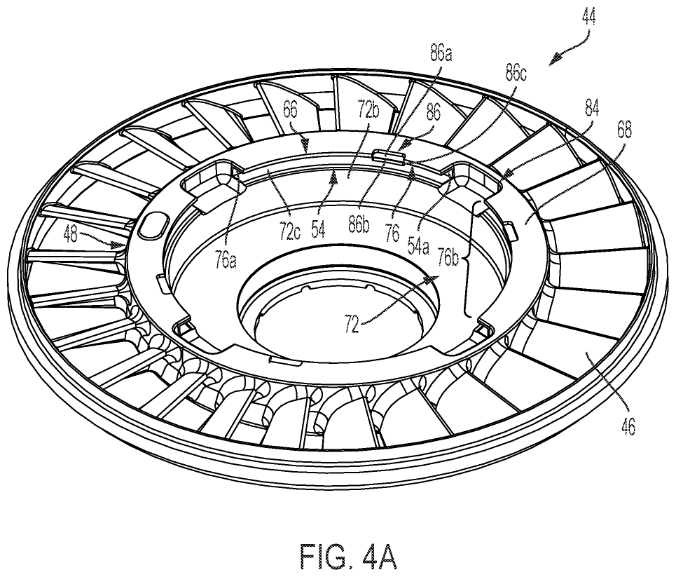

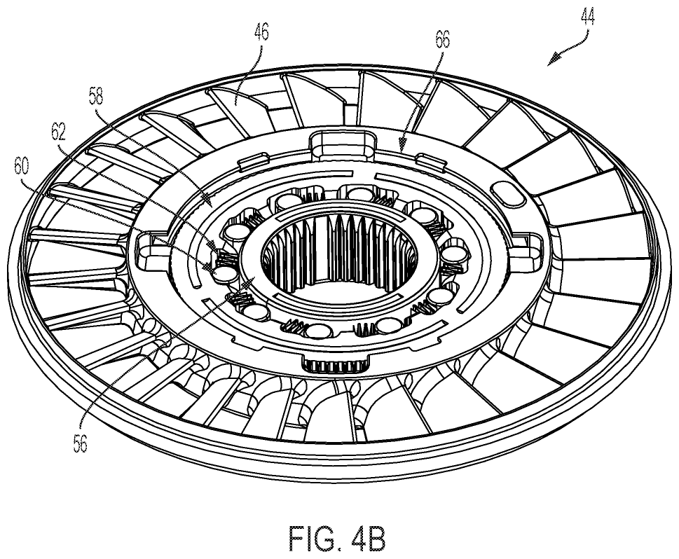

Torque converter 10 also includes a stator 42 axially between turbine 20 and impeller 18 to redirect fluid flowing from the turbine blades 26 before the fluid reaches impeller 18 to increase the efficiency of torque converter 10 as turbine 20, impeller 18 and stator 42 rotate about a center axis CA of torque converter 10. Unless otherwise specification, the terms radial, axial and circumferential and derivatives thereof are used herein reference to center axis CA. Stator 42 includes a stator casting 44 including a plurality of stator blades 46 and a stator body 48. Stator 42 also includes a one-way clutch 50 held within stator body 48 by a cover plate 52. A portion of an outer diameter of cover plate 52 is held in at least one circumferentially extending groove 54 formed in stator body 48. One-way clutch 50 includes an inner race 56, an outer race 58 and rollers 60 and springs 62 (FIG. 4b) radially between inner race 56 and outer race 58.

Stator casting 44 is rotationally fixed to outer race 58, and depending on the operating conditions of torque converter 10, inner race 56 and outer race 58 are rotationally fixed to each other or rotatable relative to each other. When impeller 18 rotates faster than turbine 20 and stator 42 is stationary, springs 62 circumferentially offset from rollers 60 press rollers 60 into wedged surfaces to rotationally fix inner and outer races 56, 58 together, preventing rotation of stator casting 44 and causing stator 42 to redirects the fluid flowing from turbine 20 to impeller 18. When impeller 18 and turbine 20 are rotating at substantially the same speed, inner race 56 and outer race 58 are rotatable relative to each other, and stator 42 rotates in same direction as impeller 18 and does not redirect the fluid flowing from turbine 20 to impeller 18.

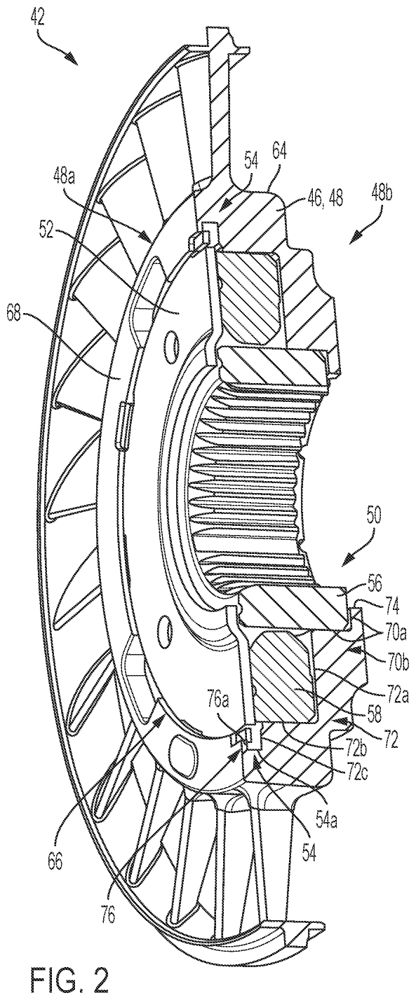

FIG. 2 shows an enlarged cross-sectional side view of stator 42 that is circumferentially offset from the view of stator 42 shown in torque converter 10 in FIG. 1. Stator 42 includes blades 46 for redirecting the torque converter fluid extending radially outward from an outer circumferential surface 64 of stator body 48. Stator body 48 includes, on axially opposite sides of stator body 48, a first axially facing side 48a and a second axially facing side 48b. First axially facing side 48a includes a radially extending surface 68 extending axially inward from outer circumferential surface 64 of stator body 48. Stator body 48 defines an annular recess 66 formed in first axially facing side 48a extending axially away from radially extending surface 68. Annular recess 66 receives one-way clutch 50. Annular recess 66 is defined by two step portions—a radially inner step portion 70 receiving inner race 56 and a radially outer step portion 72 receiving rollers 60 and outer race 58. Radially inner step portion 70 includes a radially extending surface 70a extending radially outward from an innermost circumferential surface 74 of stator casting 44 and an axially extending circumferential surface 70b extending from a radially outer edge of radially extending surface 70a. Radially outer step portion 72 includes a radially extending surface 72a extending radially outward from axially extending circumferential surface 70b of step portion 70 and an axially extending circumferential surface 72b extending from a radially outer edge of radially extending surface 72a toward first axially facing side 48a.

Stator casting 44 also includes circumferentially extending grooves 54 within annular recess 66. Circumferentially extending grooves 54 are each positioned axially between second step portion 72 and radially extending surface 68. Circumferentially extending grooves 54 are defined on a first axial side by radially outer step portion 72 and a second axial side by a rim portion 76. More specifically, rim portion 76, which is defined by on the first axial side 48a by surface 68, includes a radially extending surface 76a defining a first radially extending wall of groove 54, and radially outer step portion 72 includes a radially extending surface 72c, which extends radially from axially extending surface 72b, defining a second radially extending wall of groove 54. An axially extending surface 54a extends axially from surface 72c to surface 76a, to define an axially extending outer circumferential wall of groove 54.

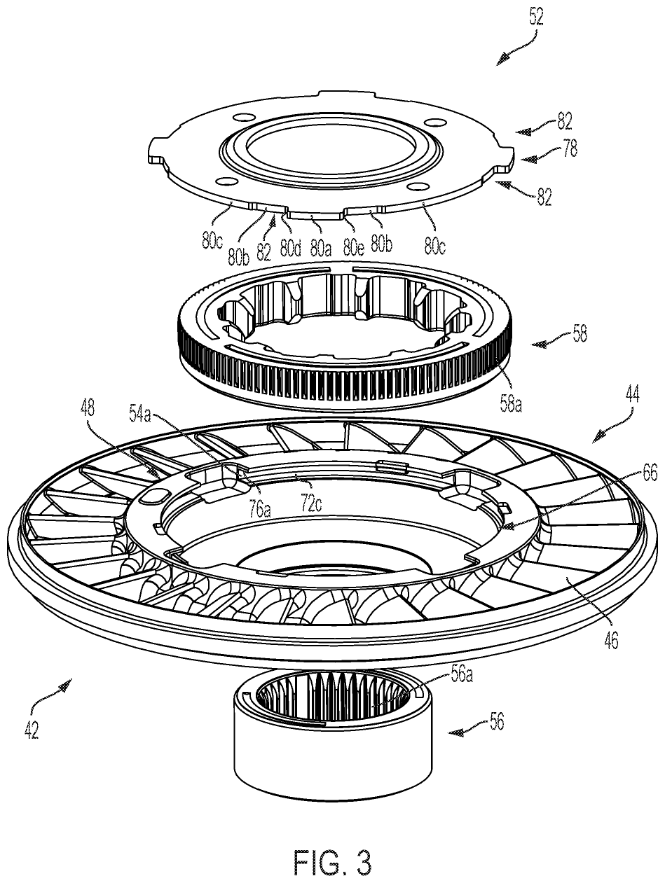

As shown clearly in FIG. 3, which illustrates an exploded view of stator 42, an outer diameter portion of cover plate 52 is configured for being received in circumferentially extending grooves 54 to axially fix cover plate 52 to stator body 48. More specifically, cover plate 52 includes an outer diameter portion in the form of a plurality of circumferentially spaced tabs 78 at the outer diameter thereof that define outermost circumferential surfaces 80a of cover plate 52. The outer circumference of cover plate 52, in addition to outermost circumferential surfaces 78a, further includes radially innermost surfaces 80b that are directly circumferentially adjacent to surfaces 80a, and radially intermediate surfaces 80c that are radially closer to center axis CA than surfaces 80a but radially further from center axis CA than surfaces 80b. Tabs 78 also include a first radially extending surface 80d on a first circumferential side of the tab 78 extending radially outward from the respective surface 80b to surface 80a and a second radially extending surface 80e on a second circumferential side of the tab 78 extending radially outward from the respective surface 80b to surface 80a.

In the example shown in FIG. 3, tabs 78 are bounded by surfaces 80b on both circumferential sides thereof and surfaces 80c are bounded by surfaces 80b on both circumferential sides thereof, such that each surface 80b is directly circumferentially between one surface 80a and one surface 80c. The radial inward offset of surfaces 80b with respect to the directly adjacent surfaces 80a, 80c defines a plurality notches 82 in the outer circumference of cover plate 52. Each of notches 82 is directly circumferentially adjacent to one of tabs 78 such that tabs 78 are each directly circumferentially adjacent to two notches 82. FIG. 3 further shows inner race 56 and outer race 58 removed from annular recess 66 in stator body 48 and allows viewing circumferentially extending grooves 54. Inner race 56 includes an inner splined surface 56a for connecting to a stator shaft and outer race 58 includes an outer splined surface 58a for connecting to axially extending surface 72b of radially outer step portion 72. Circumferentially extending grooves 54 extend circumferentially with respect to center axis CA and as noted above are defined by surfaces 54a, 72c, 76a.

FIG. 4a shows a standalone perspective view of stator casting 44 allowing a clear view of annular recess 66 and circumferentially extending grooves 54 and FIG. 4b shows a view of stator 42 with cover plate 52 omitted. In order for cover plate 52 to be installed in circumferentially extending grooves 54, rim portion 76 is provided with a plurality of circumferentially spaced slots 84—one slot 84 for each tab 78—that allow tabs 78 of cover plate 52 to axially pass through as cover plate 52 is pressed axially into annular recess 66. Slots 84 extends radially outward from axially extending surface 72b of radially outer step portion 72 past axially extending surface 54a of grooves 54 to divide rim portion 76 into a plurality of circumferentially spaced arc shaped segments 76b. Each arc shaped segment 76b includes a staked section 86 that is formed in rim portion 76 after cover plate 52 is inserted into annular recess 66. Staked sections 86 each circumferentially abut one of tabs 78 and are received in one of notches 82 to lock cover plate 52 circumferentially into place in circumferentially extending grooves 54. Staked sections 86 each include an indentation 86a formed axially into radially extending surface 68 on first axially facing side 48a of stator body 48 and a protrusion 86b extending axially from radially extending surface 76a of rim portion 76 into the respective circumferentially extending groove 54. Stator body 48 circumferentially contacts cover plate 52 to circumferentially fix cover plate 52 to stator body 48. More specifically, circumferential edge 86c of each protrusion 86b contacts a respective radially extending surface 80d or 80e of one of tabs 78 to prevent circumferential movement of cover plate 52 within circumferentially extending grooves 54.

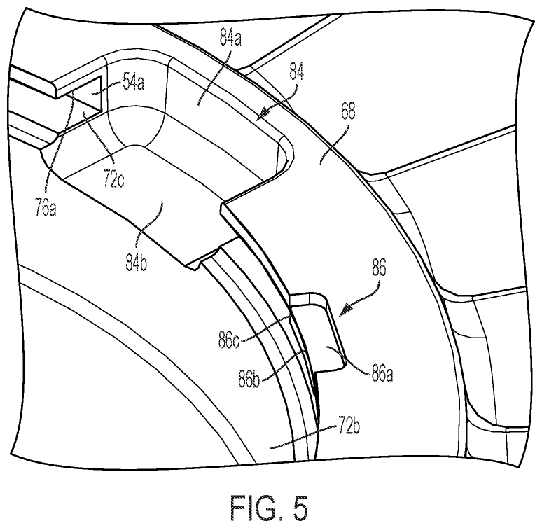

FIG. 5 shows an enlarged view of a portion of stator body 48 shown in FIG. 4 illustrating the details of one of slots 84 and one of stacked sections 86. Slot 84 includes an axially extending surface 84a extending from radially extending surface 68 and a radially extending surface 84b extending radially inward from surface 84a to axially extending surface 72b. Slot 84 has an axial depth that is greater than an axial depth of circumferentially extending groove 54 such that surface 84b is recessed in the axial direction from surface 72c of groove 54. Slot 84 also has radial depth that is greater than a radial depth of circumferentially extending groove 54 such that surface 84a is recessed in the axial direction from surface 54a of groove 54. This radial depth reduces stiffness with respect to surface 72b of stator body 48 comprising against splines 58a of outer race 58 and therefore reduces the stress state in stator casting 44.

FIG. 6 shows a cross-sectional view of a portion of stator 42 illustrating one of tabs 78 being received in circumferentially extending groove 54. Rim portion 76 radially overlaps the outer diameter portion, i.e., tabs 78, of cover plate 52. A first radially extending axial facing surface 78a of tab 78 contacts radially extending surface 76a of rim portion 76 and a second radially extending axial facing surface 78b of tab 78, which is axially opposite of surface 78a, is axially spaced from radially extending surface 72c by a distance X1 such that tabs 78 each have an axial thickness X2 that is less than an axial depth X3 of circumferentially extending groove 54 between surfaces 76a, 72c. Outermost circumferential surfaces 80a of cover plate 52, defined by tabs 78, are radially spaced from axially extending surface 54a, by a distance X4, which is for example 2 mm or greater. Rim portion 76 has an axial thickness X5, which is for example 2 mm or greater. A radially extending axial facing surface 52a of cover plate 52, which is on the same side of cover plate 52 as surfaces 78b of tab 78, axially contacts outer race 58.

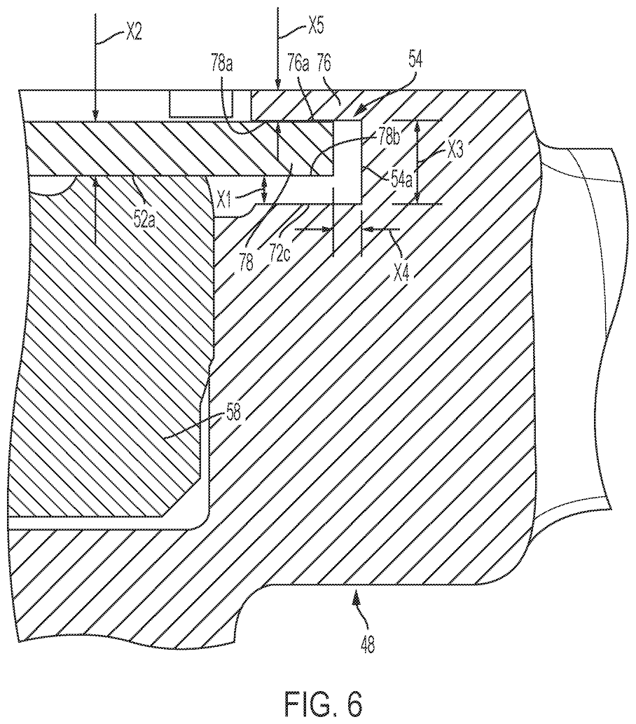

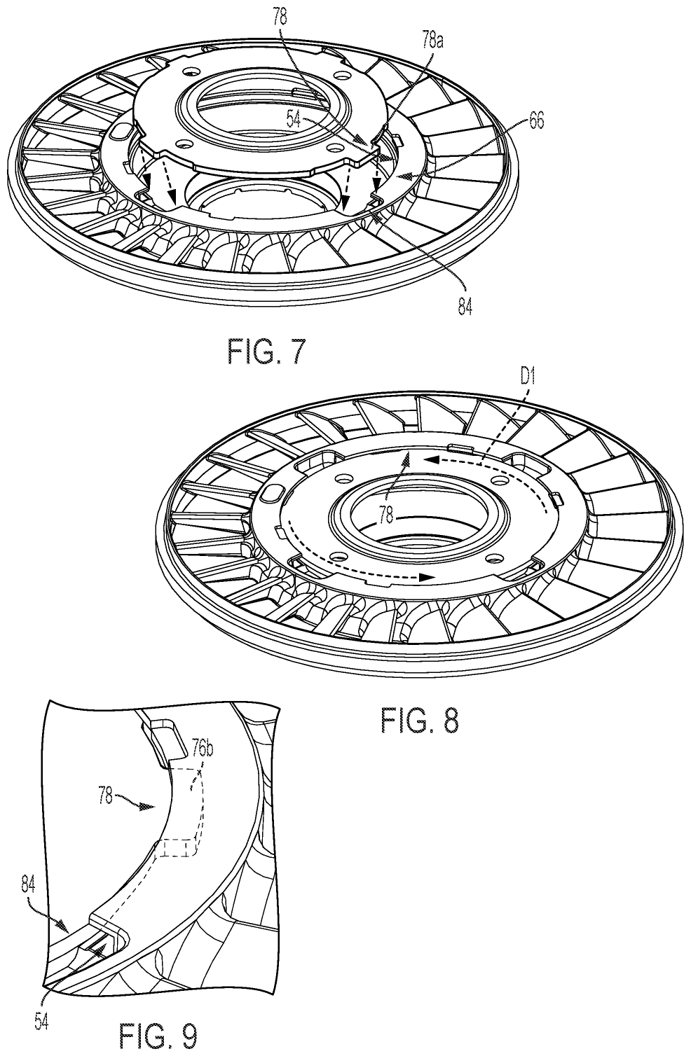

FIGS. 7 to 11 illustrates a method of constructing stator 42 by installing cover plate 52 into annular recess 66 and fixing tabs 78 of cover plate 52 in circumferentially extending grooves 54. It is noted that one-way clutch 50 is omitted from FIGS. 7 to 11, but one-way clutch 50 is installed inside of annular recess 66 before cover plate 52 is inserted into annular recess 66. After one-way clutch 50 is installed inside of annular recess 66, as shown in FIG. 7, tabs 78 are each axially aligned with one of slots 84, and cover plate 52 is pressed into annular recess 66 such that each of tabs 78 enters the respective one of slots 84 such that axially facing surface 78a of each of tabs 78 is in the recess 66 further from surface 68 than radially extending surface 76a of rim portion 76 is from surface 76.

After tabs 78 are inserted into grooves 54, as shown in FIG. 8, cover plate 52 is rotated in a rotational direction D1 a desired angular degree such that each of tabs 78 is movable circumferentially away from the respective slot 84 and into axial alignment with and a respective one of arc shaped segments 76b of rim portion 76 and surface 78a of each tab 78 is directly axially facing the respective surface 76a. Circumferential stops may be provided in each circumferentially extending groove 54 for each of tabs 78 to contact the respective tab 78 and indicate when the tabs 78 are in the correct angular orientation. Circumferential stops may be angularly positioned every n/360 degrees, where n is the number of tabs 78. For example, in the example shown in FIGS. 7 to 11, with four tabs 78, circumferential stops may be positioned every ninety degrees in circumferentially extending grooves 54 (i.e., 4/360=90). FIG. 9 illustrates one of tabs 78 axially aligned with and the respective one of arc shaped segments 76b.

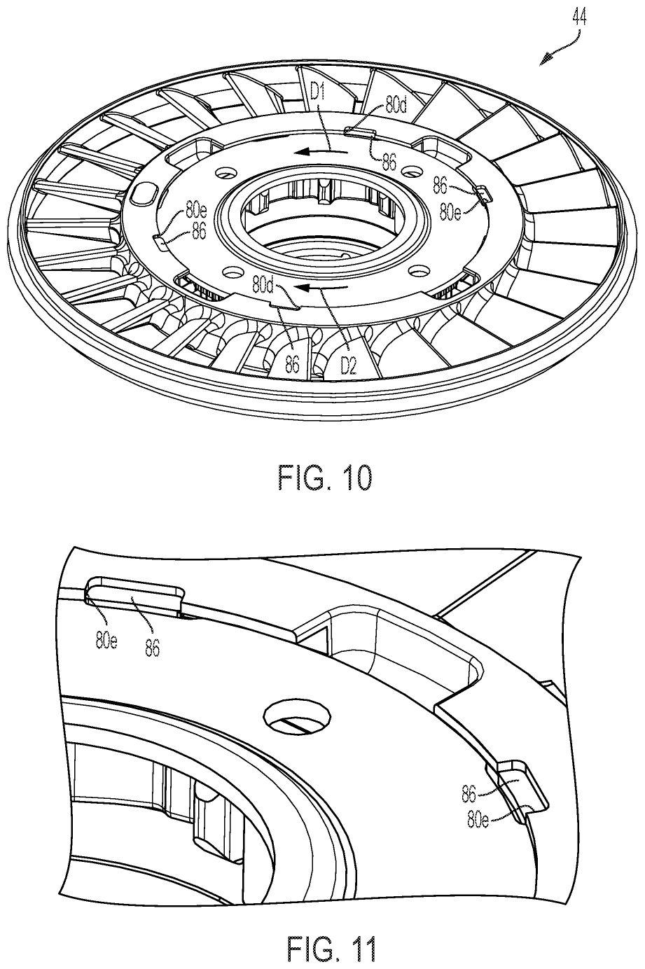

As illustrated in FIGS. 10 and 11, after tabs 78 are rotated the desired angular degree, rim portion 76 of stator body 48 is staked with a staking tool to form a plurality of staked section 86. More specifically, in the example in FIGS. 10 and 11, each of arc shaped segments 76b of rim portion 76 is staked to form a staked section 86 therein. In other words, each staked section 86 is circumferentially between two of the slots 84. At least one of the staked sections 86 (two in the example shown in FIG. 10) prevents rotation in direction D1 and at least one of the staked sections 86 (two in the example shown in FIG. 10) prevents rotation in direction D2, which is opposite of direction D1. More specifically, two of staked sections 86 contact the first radially extending surface 80d on the first circumferential side of the respective tab 78 and two of staked sections 86 contact the second radially extending surface 80e on the first circumferential side of the respective tab 78. The staked sections 86 that contact surfaces 80d thus prevent rotation in direction D2 and the staked sections 86 that contact surfaces 80e thus prevent rotation in direction D1.

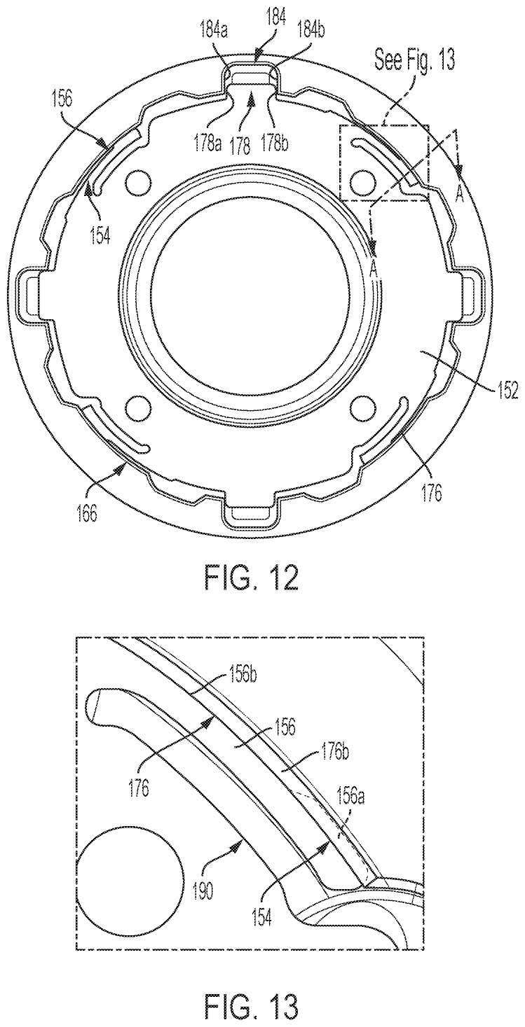

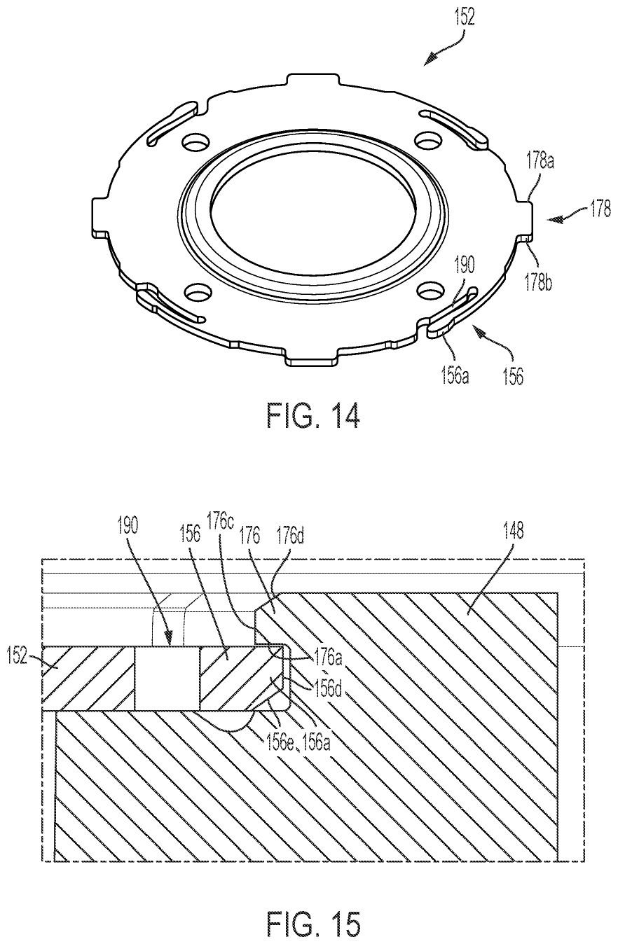

FIGS. 12 to 15 illustrate a further example of a cover plate 152 for fixing in an annular recess 166 of a stator body 148. Unless specified below and illustrated in FIGS. 12, 13 and 15, stator body 148 is configured in the same manner as stator body 48 and annular recess 166 is configured in the same manner as annular recess 66. FIG. 12 shows a plan view of cover plate 152 in stator body 148, and FIG. 13 shows a view of an enlarged portion of FIG. 12. FIG. 14 shows a standalone perspective view of cover plate 152. As shown in FIGS. 12 and 13, cover plate 152 is axially fixed in place by an outer diameter portion of cover plate 152 in the form of circumferentially extending prongs 156 at the outer diameter of cover plate 152. Stator body 148 circumferentially contacts cover plate 152 to circumferentially fix cover plate 152 to stator body 148. More specifically, tabs 178 fix cover plate 152 rotationally in place in stator body 148 by engaging with slots 184 formed in stator body 148. Tabs 178 each include two opposite radially extending surfaces 178a, 178b that contact radially extending surfaces 184a, 184b of the respective slot 184 to fix cover plate 152 radially in place in annular recess 166 of stator body 148. Stator body 148 is provided with circumferentially extending grooves 154 each configured for receiving a respective one of prongs 156. Stator body 148 includes a rim portion 176 formed by a plurality of circumferentially spaced arc shaped segments 176b and each of grooves 154 is formed in part by one of segments 176b.

As shown in FIGS. 12 to 14, an inner circumferential surface of each of prongs 156 is formed by a circumferentially extending slot 190 formed in cover plate 152 and each prong 156 is provided with a protrusion 156a on the outer circumferential surface thereof. Each of protrusions 156a protrudes radially further than a remainder of the outer circumferential surface 156b of prong 156. Each protrusion 156a is received in circumferentially extending groove 154 to hold cover plate 152 axially in place with respect to stator body 148 by contacting the respective segment 176b in the respective groove 154.

As illustrated in FIG. 15, which shows a cross-sectional view of cover plate 152 and stator body 148 along A-A in FIG. 12, a radially extending surface 176a of rim portion 176 contacts protrusion 156a at an axially facing radially extending surface 156c of prong 156 to fix cover plate 152 axially in place in annular recess 166 of stator body 148.

After one-way clutch 50 (FIG. 1) is installed inside of annular recess 166, tabs 178 are each axially aligned with one of slots 184, and cover plate 152 is pressed into annular recess 166 such that each of tabs 178 enters the respective one of slots 184 and protrusions 156a of prongs are inserted into the corresponding groove 154. Prongs 156 are pressing radially inward to move prongs 156 axially past rim portion 176. More specifically, prongs 156 are pressed radially inward such that an outermost circumferential surface 156d of each prong 156 (i.e., the outer circumferential surface of each protrusion 156a) is radially inward from an inner circumferential surface 176c of the respective rim portion 176. A chamfer surface 156e of each prong 156 may contact a chamfer surface 176d of the respective rim portion 176 to force prongs 156 radially inward.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

### LIST OF REFERENCE NUMERALS

10 torque converter
12 front cover
13 rear cover
16 impeller shell
18 impeller
20 turbine
22 turbine shell
24 turbine inner ring
26 turbine blades
28 rounded blade supporting portion of turbine shell
30 outer radial extension of turbine shell
32 impeller core ring
34 impeller blades
36 friction material
38 damper assembly
40 damper hub
42 stator
44 stator casting
46 stator blades
48 stator body
48a first axially facing side
48b second axially facing side
50 one-way clutch
52 cover plates
52a radially extending axial facing surface
54 annular groove
54a axially extending surface defining annular groove
56 inner race
58 outer race
60 rollers
62 springs
64 stator body outer circumferential surface
66 stator body annular recess
68 radially extending surface on first axially facing side of stator body
70 radially inner step portion in stator body annular recess
70a radially extending surface of radially inner step portion
70b axially extending surface of radially inner step portion
72 radially outer step portion in stator body annular recess
72a first radially extending surface of radially outer step portion
72b axially extending surface of radially outer step portion
72c second radially extending surface of radially outer step portion
74 innermost circumferential surface of stator casting
76 rim portion of stator body
76a radially extending surface of rim portion
76b circumferentially spaced arc shaped segments of rim portion
78 circumferentially spaced outer diameter tabs of cover plate
78a first radially extending axial facing surface of tabs
78b second radially extending axial facing surface of tabs
80a outermost circumferential surfaces of cover plate
80b radially inner outer circumferential surfaces of cover plate
80c radially intermediate outer circumferential surfaces of cover plate
80d radially extending surfaces of the outer circumference of cover plate
82 outer circumference notches in cover plate
84 circumferentially spaced slots
86 staked section of rim portion
86a indentation of staked section
86b protrusion of staked section
86c circumferential edge of protrusion
148 stator body
152 cover plate
154 circumferentially extending grooves
156 circumferentially extending prongs
156a outer circumferential surface radial protrusion of prongs
156b outer circumferential surface of prongs
156c axially facing radially extending surface of prong
156d outermost circumferential surface of prong
156e chamfer surface of prongs
166 annular recess
176 rim portion of stator body
176a radially extending surface of rim portion
176b circumferentially spaced arc shaped segments of rim portion
176c inner circumferential surface of rim portion
176d chamfer surface of rim portion
178 tabs
178a first radially extending axial facing surface of tabs
178b second radially extending axial facing surface of tabs
184 slots
184a first radially extending surfaces of slots
184b second radially extending surfaces of slots
190 circumferentially extending slot in cover plate

1. A stator for a torque converter comprising:
a plurality of blades;
a stator body supporting the blades, the stator body defining an annular recess formed therein;
a one-way clutch in the annular recess; and
a cover plate holding the one-way clutch in the annular recess, an outer diameter portion of the cover plate being received in a circumferentially extending groove of the stator body to axially fix the cover plate to the stator body.

2. The stator as recited in claim 1 wherein the circumferentially extending groove is within the annular recess and the stator body includes a rim portion radially overlapping the outer diameter portion of the cover plate.

3. The stator as recited in claim 2 wherein the rim portion includes a radially extending surface defining a wall of the circumferentially extending groove, the radially extending surface of the rim portion contacting a radially extending surface of the outer diameter portion of the cover plate to axially fix the cover plate to the stator body.

4. The stator as recited in claim 2 wherein the rim portion includes a plurality of circumferentially spaced slots and a plurality of circumferentially spaced arc shaped rim segments.

5. The stator as recited in claim 1 wherein the stator body circumferentially contacts the cover plate to circumferentially fix the cover plate to the stator body.

6. The stator as recited in claim 5 wherein the cover plate includes a plurality of radially extending tabs, the stator body circumferentially contacting the radially extending tabs to circumferentially fix the cover plate to the stator body.

7. The stator as recited in claim 6 wherein the stator body includes a plurality of staked sections, each of the staked sections contacting a respective one of the radially extending tabs to circumferentially fix the cover plate to the stator body.

8. The stator as recited in claim 1 wherein the outer diameter portion of the cover plate is formed by a plurality of radially extending tabs.

9. The stator as recited in claim 8 wherein each of the radially extending tabs axially contacts a rim portion of the stator body to axially fix the cover plate to the stator body.

10. The stator as recited in claim 1 wherein the outer diameter portion of the cover plate is formed by a plurality of circumferentially extending prongs.

11. The stator as recited in claim 10 wherein each of the circumferentially extending prongs includes an outer radial protrusion axially contacting a rim portion of the stator body to axially fix the cover plate to the stator body.

12. A torque converter comprising:
a turbine;
an impeller; and
the stator as recited in claim 1 axially between the turbine and the impeller.

13. A stator for a torque converter comprising:
a plurality of blades;
a stator body supporting the blades, the stator body defining an annular recess formed therein;
a one-way clutch within the annular recess; and
a cover plate holding the one-way clutch within the annular recess, the cover plate includes radially extending tabs at an outer diameter thereof being received in a circumferentially extending groove of the stator body within the annular recess to axially fix the cover plate to the stator body, the stator body including staked sections, each of the radially extending tabs contacting a respective one of the staked sections to circumferentially fix the cover plate to the stator body.

14. The stator as recited in claim 13 wherein the stator body includes a rim portion radially overlapping the radially extending tabs.

15. The stator as recited in claim 14 wherein the rim portion includes a plurality of circumferentially spaced arc shaped segments, each of the radially extending tabs axially contacting a radially extending surface of a respective one of the circumferentially spaced arc shaped segments.

16. The stator as recited in claim 15 wherein the stator body includes a plurality of slots extending radially outward from the annular recess, the slots dividing the rim portions into the plurality of circumferentially spaced arc shaped segments

17. A method of forming a torque converter stator comprising:
providing a cover plate and a stator body including an annular recess;
inserting a one-way clutch into the annular recess of the stator body;
axially fixing the cover plate to the stator body so the cover plate holds the one-way clutch in the stator body by inserting an outer diameter portion of the cover plate in a circumferentially extending groove of the stator body.

18. The method as recited in claim 17 wherein the outer diameter portion of the cover plate is formed by a plurality of radially extending tabs, the circumferentially extending groove is formed by a plurality of circumferentially extending grooves and the stator body includes a plurality of slots extending radially outward from the annular recess,
the inserting of the outer diameter portion of the cover plate in the circumferentially extending groove of the stator body includes pressing each of the tabs into a respective one of the slots, and rotating the cover plate to force each of the radially extending tabs into a respective one of the circumferentially extending grooves.

19. The method as recited in claim 18 further comprising axially staking the stator body to circumferentially fix the cover plate to the stator body.

20. The method as recited in claim 17 wherein the outer diameter portion of the cover plate is formed by a plurality of circumferentially extending prongs and the circumferentially extending groove is formed by a plurality of circumferentially extending grooves,
the inserting of the outer diameter portion of the cover plate in the circumferentially extending groove of the stator body includes forcing the circumferentially extending prongs radially inward while pressing the cover plate into the annular recess.
